(19) United States
(12) Patent Application Publication
(10) Pub. No.: US 2014/0159914 A1
(43) Pub. Date: Jun. 12, 2014

(54) ELECTRONIC REPORTING SYSTEMS AND METHODS

(71) Applicant: Alan C. Heller, Dallas, TX (US)

(72) Inventor: Alan C. Heller, Dallas, TX (US)

(21) Appl. No.: 13/949,819

(22) Filed: Jul. 24, 2013

Related U.S. Application Data
(60) Provisional application No. 61/675,024, filed on Jul. 24, 2012.

(51) Int. Cl. G08C 17/02

(52) U.S. Cl. CPC G08C 17/02
USPC 340/870.02

(57) ABSTRACT

The present invention is directed to a system and process for electronic reporting of a sensor monitored process. The system includes a reader associated with a monitored process and in communication with a server over a network. The reader is configured for input from at least one sensor. The sensors are paired with a reader, whereby the reader is configured to relay the sensor output to the server. The system monitors the reader for output from the sensor. On receipt of the reader data, the system retrievably stores the data for compliance report review.

The present invention claims priority to provisional application 61/675,024, which has a filing date of Jul. 24, 2012 and is incorporated by reference.

### BACKGROUND

1. Field Of The Invention

The present invention relates to reporting systems, more specifically to electronic reporting systems incorporating sensor data.

2. Description Of The Related Art

Compliance reporting is a key part of process standards such as the ISO900x series, and food process equivalents such as HACCP (‘Hazardous Analysis of Critical Control Points’) or ISO 22000, where a planned sequence of observations or measurements is recorded for analysis. The documentation is used to better control processes and study past reports in light of detected problems or defects, minimizing defects, or mitigating post-process damage to involved parties. Compliance reports are used for detecting deviations from critical control points during a monitored process and can trigger action to apply control in order prevent, eliminate, or reduce food safety hazards. When problems occur after a cycle of the monitored process, the compliance reports are used to review the batch and any deviations that occurred during that specific cycle. Where the compliance reports are paper-based, analysis such as pattern analysis, is hindered. Often the writings from the paper-based compliance reports are later input into a system.

These stringent compliance reports are typically produced by a responsible establishment official of the process during an audit in order to demonstrate a high level of control and efficiency in the overall process. Compliance reports require a great deal of measurement and data entry from disparate sources such as bar coding, web processing, and RFID corresponding to one or more control points of the process. A compliance report would then show times, measurements, and observations for those control points. Process-monitoring instruments or devices are used to indicate conditions during processing at a critical control point. Input conditions for the control point could be the temperature and/or humidity in a particular refrigerator, a pressure gauge, or voltage measurements on certain places on process equipment. These inputs must be taken at precise times in order to achieve the optimum result of the process implementation. The process and repetition can be involved and lead to additional manpower or measurements taken at inconsistent times leading to lowered compliance report value. Although the results of standards are appreciated, their implementation has met resistance due to the burden. It would be advantageous for the art to have a paperless, automated reporting system. This invention addresses that issue.

### SUMMARY

The present invention is directed to a system and process for electronic reporting of a sensor monitored process. The system includes a reader associated with a monitored process and in communication with a server over a network. The reader is configured for input from at least one sensor. The sensors are paired with a reader, whereby the reader is configured to relay the sensor output to the server. The system monitors the reader for output from the sensor. On receipt of the reader data, the system retrievably stores the data for compliance report review.

These and other features, aspects, and advantages of the invention will become better understood with reference to the following description, appended claims, and accompanying drawings.

### BRIEF DESCRIPTION OF THE DRAWINGS

FIG. 1 shows a block diagram of the major elements of an embodiment according to the current invention;

FIG. 2 shows a block diagram of the major elements of an embodiment according to the current invention;

FIG. 3 shows a block diagram of the major elements of the embodiment of FIG. 2 as it may exist in operation; and

FIG. 4 shows a flowchart of a process implemented to the embodiment of FIG. 2.

### DETAILED DESCRIPTION

While the foregoing detailed description has disclosed several embodiments of the invention, it is to be understood that the above description is illustrative only and not limiting of the disclosed invention. It will be appreciated that the discussed embodiments and other unmentioned embodiments may be within the scope of the invention.

Critical control points of a process standard are employed in many institutions or control systems such as an HVAC system, a hospital, a food production line, an oil refinery, and other systems. In a food production line, for example, food temperatures must exceed pasteurization over a pre-configured period or the resulting food is subject to further inspection and may be discarded.

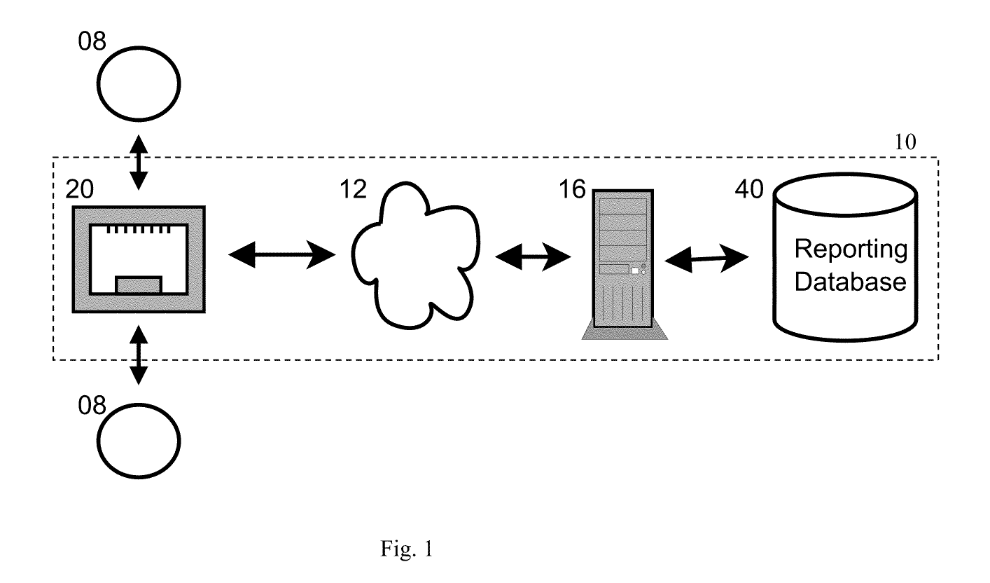

The current invention is directed to a system and process for receiving input from a plurality of sensors in order to store data for compliance reports. FIG. 1 depicts the major elements of an embodiment of the invention. Depicted are a sensors 08, a reader 20, a network 20, a server 16, and a reporting database 40.

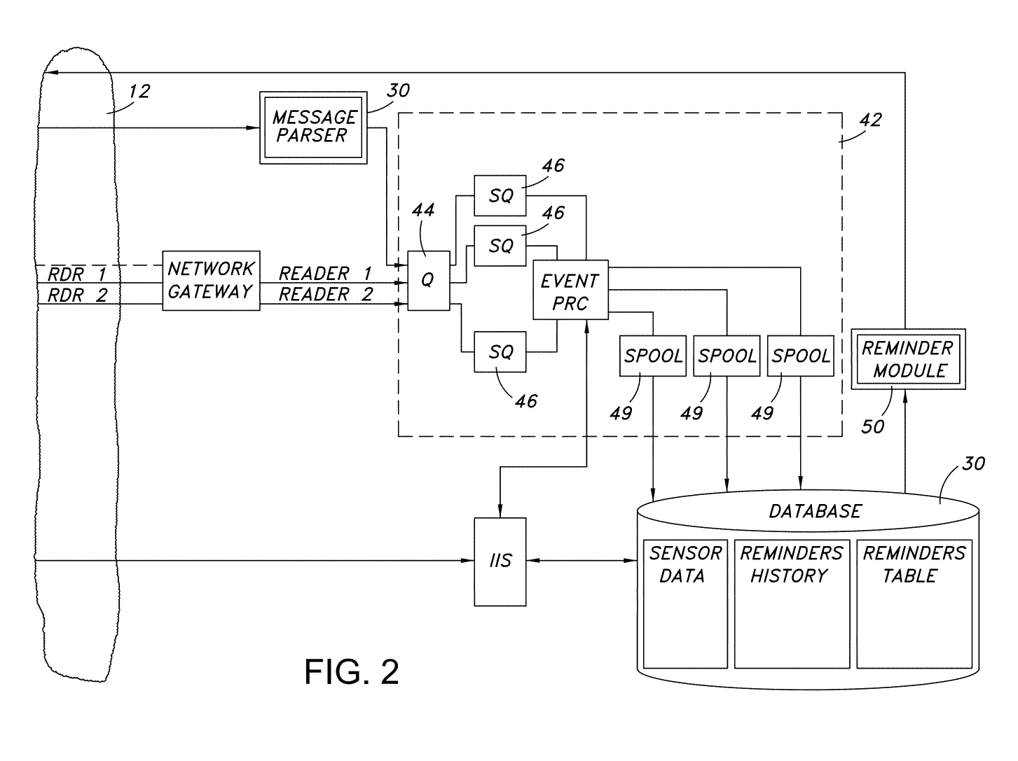

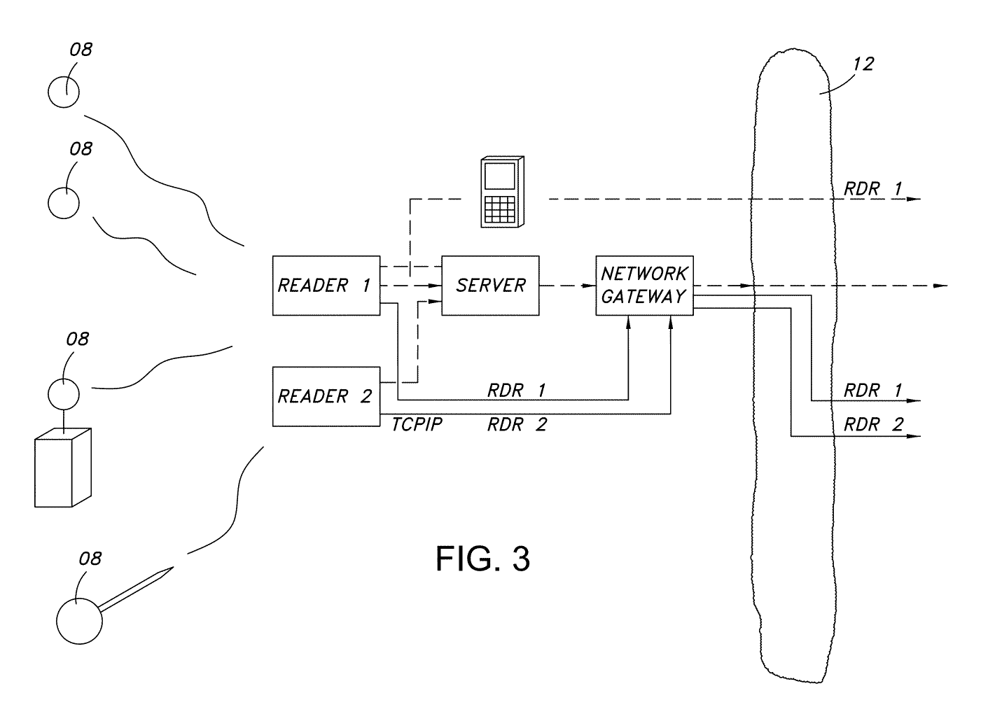

The system 10 is configured to receive input from sensors 08 directly or through human input. Sensor 08, as used within the specification mean a device that measures a physical property within the subject environment and converts it into a signal which can be read by an observer or device. In the exemplary output for this invention, the sensor 08 output is transformed to an electrical signal encoding the measured property. It is to be understood that sensors may output in other formats such as bar code data, visual indicators, or other formats known in the art. The sensor 08 may incorporate a power source and local memory for storage of output, time stamps, and related data. Sensors 08 are associated with a control point within a monitored process. Sensors can include, but are not limited to temperatures sensors, pressure sensors, voltage sensors, light sensors, motion sensors, chemical sensors, biological sensors, and the like. In the exemplary embodiment, the sensor 08 includes a unique identifier and is associated with a user-defined process and an operator. FIG. 2 illustrates a room thermometer and a thermometer associated with the interior of a refrigerator.

Still referring to FIG. 2, a reader 20 is in communication with one or more sensors 08, from wired or wireless sensors 08. The reader includes a decoder operable to decode the sensor data. The decoder can include an analog to digital converter, digital to analog converter, bar code reader, RFID reader, or other devices known in the art. Additionally, the decoder can include a translator in order to convert the format of the sensor 08 output. Optionally, when the sensor 08 is paired with the reader 20, the reader 20 records the signal strength of the sensor 20 in order to facilitate future identification of that sensor 20. The reader 20 includes memory and communication apparatus. The reader 20 is configured to receive the output data of the sensors 08 and relay the sensor data for further processing. Representative data relayed includes the sensor 08 identifier, the sensor 08 data, a time stamp, a responsible party, and a checksum for the relayed data. In one configuration, the checksum is hashed, further minimizing authenticity issues. The preferred communication apparatus is a telephone or computer network interface in order to connect to the network 12. In exemplary operation, the reader 20 includes a unique identifier for assignment to a process.

As previously disclosed, the reader includes communication apparatus to relay sensor 08 data over a network. The exemplary network 12 includes a computer network and a telephone network. The computer network includes of a variety of network components and protocols known in the art which enable computers to communicate. The computer network may be a local area network or wide area network such as the internet. The network may include modem lines, high speed dedicated lines, packet switches, etc. The network protocols used may include those known in the art such as UDP, TCP, IP, IPX, or the like. Additional communication protocols may be used to facilitate communication over the computer network, such as the published HTTP protocol used on the world wide web or other application protocols.

The telephone network is the circuit-switched telephone network worldwide network of telephone lines, fiber optic cables, microwave transmission links, cellular networks, communications satellites, and undersea telephone cables connected by switching centers, which allows any telephone in the world to communicate with any other. More specifically, it includes a system capable of transmitting text communications internally via protocols such as the Short Message Service. Alternatively, it can support digital transmission of data over the telephone system and routing data to and from the computer network such via such protocols as 3G, 4G, LTE, and WiMax.

The system 10 includes a server 16 for communication with the readers 20 and storage of the reporting database 40. A computer or server 16, as referred to in this specification generally refers to a system which includes a central processing unit (CPU), memory, a screen, a network interface, and input/output (I/O) components connected by way of a data bus. The I/O components may include for example, a mouse, keyboard, buttons, or a touchscreen. The network interface enables data communications with the network 12. A server contains various server software programs and preferably contains application server software such as Microsoft's Internet Information Server. Those skilled in the art will appreciate that server 16 may take a variety of configurations, including personal computers, hand-held devices, multi-processor systems, microprocessor-based electronics, network PCs, minicomputers, mainframe computers, and the like. Additionally, the server 16 may be part of a distributed computer environment where tasks are performed by local and remote processing devices that are linked. Although shown as separate devices, one skilled in the art can understand that the structure of and functionality associated with the aforementioned elements can be optionally partially or completely incorporated within one or the other, such as within one or more processors.

The reporting database 40 includes process configuration parameters and historical sensor 08 data. The process configuration parameters are information specific to a user-defined process for which sensor 08 data will be received by the system 10. As disclosed, the system 10 receives sensor data 08 for a given monitored process. Each process monitors specific control points therein. These control points will be monitored by different types of sensors 08 and at specific instances. The process configuration parameters include the process name, the types of sensors 08 employed in the subject process, the expected data transmission from the sensor 08 and/or reader 20 pair, the expected frequency or trigger event for sensor 08 output, and related data. The historical sensor 08 data includes the sensor 08 identifier, sensor 08 output data, and a timestamp.

The reporting database 40 receives sensor 08 data input from two primary sources, namely the readers 20 and the message parser 30. The readers 20 enable direct sensor 08 communication with the system 10. The message parser 30 facilitates human-aided sensor 08 input into the system 10. In some cases, human interaction may be necessary to set up the reader 20 to server 16 communication, the control point may require human interaction to provide sensor 08 supplemented input into the system 10, or other requirements may exist for human interaction. The message parser 30 facilitates human interaction with the system 10 via an instruction set. Although the message parser 30 supports varying communication protocols, the exemplary communication protocols for interaction are email and short message service (SMS). The message parser translates the human input according to the instruction set for further system 10 processing.

As mentioned, the system 10 enables human interaction via an instruction set. The primary commands of the instruction set include instructions to assign a sensor 08 or reader 20 to the system 10, update sensor 08 or reader 20 settings, input sensor 08 or reader 20 output into the system 10. The instruction sets are optimized for the transmission medium, with the exemplary system 10 including two instruction sets. The first is a terse instruction set optimized for instruction transmission over SMS. Its instruction set is designed to incorporate the instruction and the parameters in less than 160 characters. A representative instruction might be a text message command instruction (eg “SENS_OUT:”), the process name, the sensor identifier, the sensor 08 reading, and the time of the reading. A second instruction set is a verbose instruction set optimized for instruction transmission over email. This instruction set is designed to enable more natural language and format supported by email. A representative instruction might be an emailed command instruction (eg “Submit sensor output”), the process name, the sensor identifier, the sensor 08 reading, the time of the reading, and a signature. The message parser 30 checks the incoming message for conformity with the instruction set, and relays the instruction to the queue 42 (disclosed below) for processing.

In order to facilitate high volume sensor 08 data input, the system 10 optionally incorporates queue elements 42, operable to distribute processing workload for database access. The depicted queue elements 42 include a master queue 44, plural sub-queues 46, an event processor 48, and plural database spoolers 49. The master queue 44 receives input from the readers 20 or from the message parser 30. The master queue 44 distributes tasks to the sub-queues 46. After processing, the sub-queues 46 relay the input to the event processor 48. The event processor 48 formats the queue 44 46 output for preparation for database writes. The event processor 48 then distributes the formatted data to the spoolers 49 for writing to the reporting database 40.

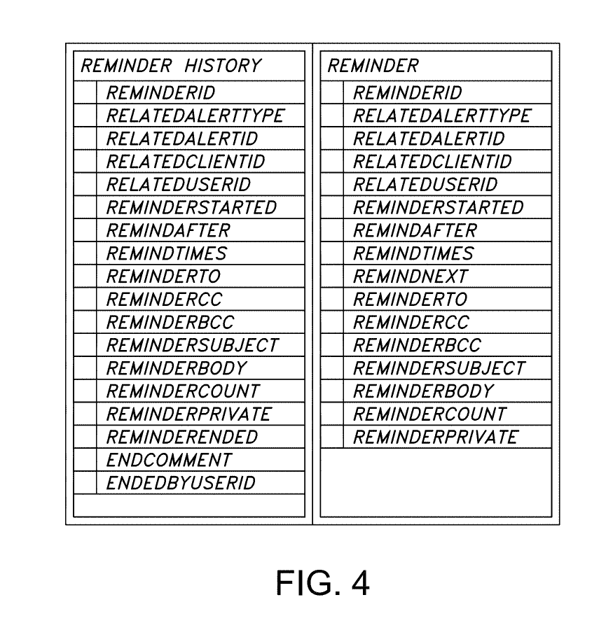

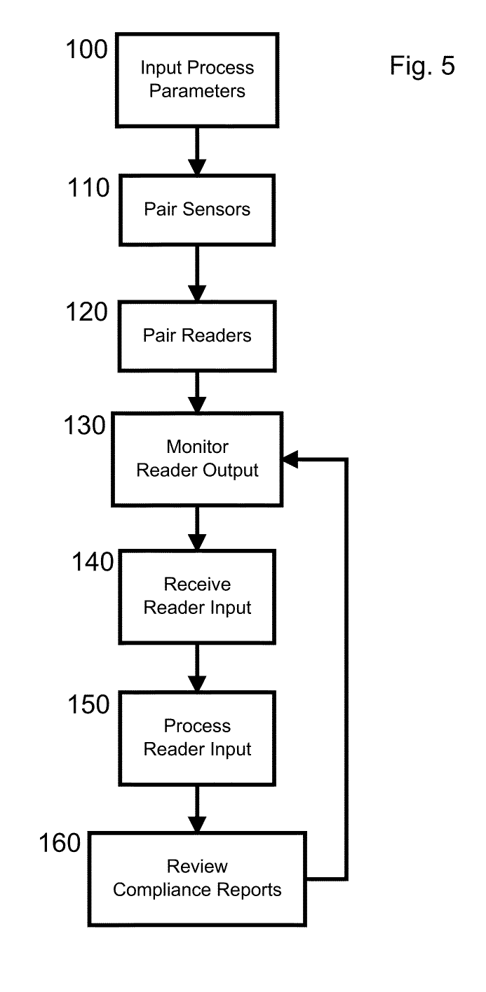

In some cases, direct input from sensors 08 may not meet the requirement of a control point or human input of observations or the like is necessary for compliance reporting. Alternatively, there can be failures in the monitoring process, such as sensor 08 failure, reader 20 failure, network failure, or the like. The system 10 includes a reminder module 50 in order to notify a responsible party for the process. The reminder module 50 constructs a reminder table based on the upon the readers 20 associated with the system 10. As disclosed, the reporting database 40 includes user-defined process configuration parameters, which includes the sensors 08 associated with a process, the sensor 08 reporting intervals or triggers, and contact information for the responsible parties. The reminder module 50 extracts the timing requirements for sensor 08 input and contact information for the responsible parties. FIG. 4 illustrates a representative partial database schema for the reminders table. The system periodically polls the historical sensor 08 data and the reminder table. In the event that a directly connected reader 20 does not provide input in the configured time period or periodic human input is required, the reminder module 50 sends a notification to the responsible party for action or further investigation.

In order to support accuracy and integrity of the human input sensor data, the system optionally incorporates an authentication module. In exemplary configuration, the authentication module is included in the message parser 30, although it may be implemented in the reader 20. The verifier is displayed at the reader 20 or at the device used to transmit the message to the message parser 30. In the message from the reminder module or upon receipt of sensor 08 data to the message parser 30, the system 10 generates a verifier in the form of a number, phrase, or word for presentation to the party responsible for the input. In one configuration, the verifier is based on the current time and sensor data. Where the message parser 30 responds to the manually input sensor data with the verifier, the user is required to confirm the verifier. In one configuration, the responsible party replies contemporaneously in text with the verifier. In another configuration, the responsible party verbally responds and the reader 20 or user telephone captures the audio. The verifier response is incorporated into the sensor 08 data.

Upon recording the sensor 08 data, the compliance reports for the desired processed can be accessed as known in the art. The exemplary report format includes a web accessible report has the appearance of a handwritten log, displaying the responsible party, the sensor identifier, the timestamp, and the sensor value.

Having disclosed the elements of the system 10, referring to FIG. 5, use of the system 10 is shown. The configuration parameters are input into the system 100. The monitored process is named, the identifiers of the sensors 08 is input, the type of sensors 08 is input, the expected sensor frequencies or triggers for output, and the expected sensor 08 output format is input. The sensors 08 are paired with readers 20 establishing the communication link 110. The readers' 20 communication link with the server 16 is established 120. The system monitors for reader 20 output 130. Where the readers 20 are transmitting sensor 08 data, that sensor 08 data is passed to the queue 42 for processing. Where the readers 20 fail to communicate sensor 08 data according to the configuration parameters, the reminder module 50 notifies the responsible party of the failure status. The system 10 receives reader 20 input. Where the reader is in direct communication with the system 10, the reader 20 data is passed to the queue. Where a responsible party transmits input via SMS or email, the message parser 30 translates according to the instruction set. The system 10 processes and writes the sensor 08 data to the reporting database 40 150. The compliance reports are available for review through a reporting interface 160.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. An electronic reporting system comprising:
at least one reader, a server, and a network;
said server configured to receive user-defined process parameters for a sensor monitored process, said process parameters including sensor types and sensor output;
said reader, including a sensor decoder and a communication apparatus, and paired to a sensor defined in said user-defined process parameters;
said sensor decoder configured to receive sensor data from at least one sensor, said communication apparatus configured to relay said sensor data over said network to said server;
said server communicately coupled to said reader over said network and configured to receive said sensor data from said reader and store said sensor data in a reporting database.

2. The system of claim 1, wherein said server further comprises a reminder module, said reminder module configured to process said user-defined parameters and calculates expected sensor input times.

3. The system of claim 2, wherein said reminder module is configured to send notifications to a responsible party associated with said user-defined process at or proximate said expected sensor input times.

4. The system of claim 2, wherein said reminder module is configured to send notifications to a responsible party associated with said user-defined process proximate nonreceipt of sensor data at said expected sensor input times.

5. The system of claim 1, wherein said network comprises a computer network.

6. The system of claim 1, wherein said network comprises a telephone network.

7. The system of claim 1, wherein said server further comprises a message parser, said message parser configured to received human-entered instructions conforming to an instruction set.

8. The system of claim 7, wherein said instruction set is a terse instruction set.

9. The system of claim 7, wherein said instruction set is a verbose instruction set.

10. The system of claim 1, further comprising a master queue configured to distribute incoming sensor data processing workload and a spooler configured to distribute database access.

11. The system of claim 1, further comprising a verification module, said verification module configured to present a verifier to a party submitting sensor data, capture a verifier response, and incorporate said verifier response into said sensor data.

12. A method of electronically reporting data, said method comprising the steps of:
providing a server and a network;
said server receiving user-defined process parameters for a sensor monitored process, said process parameters including sensor types and sensor output;
providing a reader, said reader including a sensor decoder and a communication apparatus;
pairing said reader to a sensor defined in said user-defined process parameters;
said sensor decoder receiving sensor data from at least one of said sensors and said communication apparatus relaying said sensor data over said network to said server;
said server receiving said sensor data from said reader and storing said sensor data in a reporting database.

13. The method of claim 12, wherein said server further comprises a reminder module, said reminder module configured to process said user-defined parameters and calculates expected sensor input times.

14. The method of claim 13, wherein said reminder module is configured to send notifications to a responsible party associated with said user-defined process at or proximate said expected sensor input times.

15. The method of claim 13, wherein said reminder module is configured to send notifications to a responsible party associated with said user-defined process proximate nonreceipt of sensor data at said expected sensor input times.

16. The method of claim 12, wherein said network comprises a computer network.

17. The method of claim 12, wherein said network comprises a telephone network.

18. The method of claim 12, wherein said server further comprises a message parser, said message parser configured to received human-entered instructions conforming to an instruction set.

19. The method of claim 18, wherein said instruction set is a terse instruction set.

20. The method of claim 18, wherein said instruction set is a verbose instruction set.

21. The method of claim 12, further providing a master queue configured to distribute incoming sensor data processing workload and a spooler configured to distribute database access.

22. The method of claim 1, further providing a verification module, said verification module configured to present a verifier to a party submitting sensor data, capture a verifier response, and incorporate said verifier response into said sensor data.
